(19) United States
(12) Patent Application Publication
(10) Pub. No.: US 2025/0249532 A1
(43) Pub. Date: Aug. 7, 2025

(54) OPTICAL PROCESSING METHOD AND OPTICAL PROCESSING APPARATUS

(71) Applicant: CANON KABUSHIKI KAISHA, Tokyo (JP)

(72) Inventors: HIROKAZU USAMI, Kanagawa (JP); KENTA KUBO, Kanagawa (JP); HIROSHI TANIUCHI, Kanagawa (JP); IKUO NAKAZAWA, Kanagawa (JP); YOHEI MASADA, Tokyo (JP); TAKAHARU AOTANI, London (GB)

(21) Appl. No.: 19/039,496

(22) Filed: Jan. 28, 2025

(30) Foreign Application Priority Data
Feb. 1, 2024 (JP) 2024-014043

(51) Int. Cl. B23K 26/08; B23K 26/14

(52) U.S. Cl. CPC B23K 26/0869; B23K 26/1462

(57) ABSTRACT

An optical processing method for performing a processing operation on a target surface of a workpiece by an optical processing apparatus including a nozzle that lets a light beam and a placement part having a placement surface for placing the workpiece. The nozzle includes a diaphragm member having an aperture configured to let at least part of the light beam pass through in an end portion facing the placement surface. The diaphragm member has an arcuate shape convex toward the placement surface and includes an elastic part elastically deformable in a direction intersecting the placement surface. When processing the workpiece, the diaphragm member is pressed against the workpiece to elastically deform the elastic part. The nozzle is moved relative to the workpiece while pressing the workpiece with an elastic force of the elastic part, and the nozzle irradiates the workpiece with the light bean from the nozzle.

### BACKGROUND

### Technical Field

The present disclosure relates to an optical processing method and an optical processing apparatus.

### Description of the Related Art

Methods for processing a workpiece to a predetermined shape by irradiating it with a laser through a mask are conventionally known. Japanese Patent Application Publication No. S63-42128, for example, discloses a technique for creating a pattern in a thin film covering a substrate by irradiating the thin film with an excimer laser through a mask pattern. Meanwhile, Japanese Patent Application Publication No. H9-192871 describes a technique for creating a pattern in a substrate while preventing a thin film covering the substrate from peeling. According to this technique, a freely movable nozzle is pressed against the workpiece with a pressure of an assist gas, as the workpiece is irradiated with the laser.

However, in both techniques, processing operations with an accuracy of less than 0.1 mm led to the possibility of processing errors due to variations in the workpiece distance caused by distortions in the substrate. The freely movable nozzle is pressed against the workpiece with a substantially constant force of gas in Japanese Patent Application Publication No. H9-192871. However, if there is a large distortion in the workpiece, the nozzle may not be able to follow the profile at a high processing (scanning) speed, which may result in processing errors. This sets an upper limit to the scanning speed.

### SUMMARY

Some embodiments of the present disclosure were made in view of these disadvantages and provide an optical processing apparatus and an optical processing method that allow following of distortions in workpieces regardless of the scanning speed to enable highly accurate and efficient processing of micro-patterns.

An aspect of the present disclosure is an optical processing apparatus comprising a light source, an optical element configured to focus light emitted from the light source toward a workpiece, a nozzle configured to let a light beam focused by the optical element pass through, and a placement part having a placement surface for placing the workpiece, the optical processing apparatus being configured to perform a processing operation on a target surface of the workpiece by irradiating the workpiece with the light beam from the nozzle while moving the nozzle and the workpiece relative to each other in a first direction parallel to the placement surface, wherein the nozzle includes a diaphragm member provided with an aperture in an end portion facing the placement surface, the aperture being configured to let at least part of the light beam pass through, and wherein the diaphragm member has an arcuate shape convex toward the placement surface in a cross section perpendicular to a second direction when no external forces are applied, and includes an elastic part elastically deformable in a third direction, where the second direction is a direction perpendicular to the first direction and parallel to the placement surface and the third direction is a direction intersecting the placement surface.

Further features of various embodiments of the present disclosure will become apparent from the following description of exemplary embodiments with reference to the attached drawings.

### BRIEF DESCRIPTION OF THE DRAWINGS

FIG. 1 is a schematic diagram of an optical processing apparatus according to Embodiment 1.

FIG. 2 is a perspective view illustrating a nozzle unit according to Embodiment 1.

FIG. 3A to FIG. 3C are cross-sectional views illustrating how the nozzle unit according to Embodiment 1 deforms.

FIG. 4A to FIG. 4D are cross-sectional views illustrating how the nozzle unit according to Embodiment 1 follows a distortion in a workpiece.

FIG. 5A and FIG. 5B are cross-sectional views illustrating a nozzle unit according to Embodiment 2.

FIG. 6A to FIG. 6C are diagrams three-dimensionally illustrating examples of a surface of a diaphragm member according to Embodiment 2.

FIG. 7A to FIG. 7C are diagrams illustrating variations in the distance between the diaphragm member and the workpiece according to Comparative Embodiment 1.

FIG. 8A to FIG. 8C are diagrams illustrating variations in the focal point of a light beam and the position of the workpiece according to Comparative Embodiment 2.

FIG. 9 is a diagram illustrating a configuration example that increases the pressing force applied to the workpiece by the diaphragm member according to Embodiments 1 and 2.

FIG. 10 is a table showing the evaluation of the processing performed on workpieces using the configurations according to the embodiments and Comparative Embodiments.

FIG. 11A to FIG. 11D are diagrams showing the results of the processing performed on workpieces using the configurations according to the embodiments and Comparative Embodiments.

### DESCRIPTION OF THE EMBODIMENTS

Embodiments of the optical processing apparatus according to the present disclosure will be hereinafter described with reference to the drawings. It should be noted that the sizes, materials, shapes, and relative arrangement or the like of constituent components described in the following embodiments should be altered suitably in accordance with the configuration and various conditions of an apparatus to which the present disclosure is applied, and are not intended to limit the scope of the present disclosure to the following embodiments.

### Embodiment 1

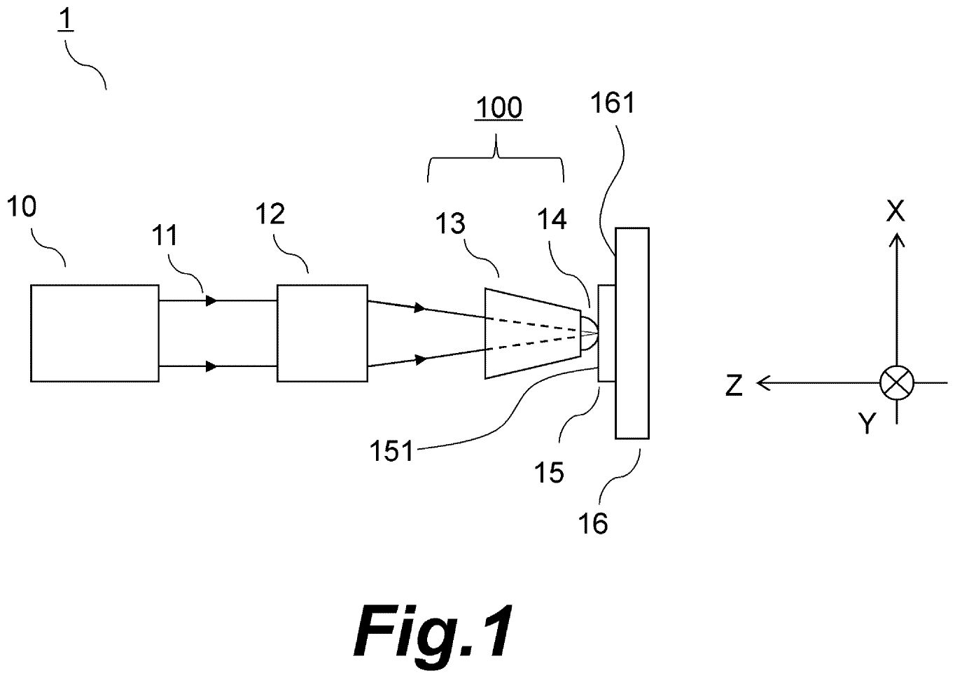

FIG. 1 is a schematic diagram of an optical processing apparatus 1 according to Embodiment 1 of the present disclosure. As shown in FIG. 1, the optical processing apparatus 1 includes a light source 10, an optical element 12 that focuses a light beam 11 emitted from the light source 10 toward a workpiece 15, and a guide part 13 (nozzle) that guides the light beam 11 focused by the optical element 12 toward a target surface 151 of the workpiece 15. The optical processing apparatus 1 further includes a diaphragm member 14 that lets at least part of the light beam 11 pass through, and a stage 16 that is a placement part having a placement surface 161 for placing the workpiece 15. The guide part 13 and the diaphragm member 14 form a nozzle unit 100 (laser processing head). The optical processing apparatus 1 irradiates the workpiece 15 with the light beam 11 from the nozzle unit 100 while moving (scanning) the nozzle unit 100 and the workpiece 15 relative to each other in a direction parallel to the placement surface 161. Micro-patterns or the like are thus created on the target surface 151 of the workpiece 15. The optical processing apparatus 1 of Embodiment 1 can be used, for example, in the process of manufacturing particle patterns in the cathode sheet of an all-solid-state battery, but is not limited to this and can be applied generally to any laser microprocessing. Hereinafter, the moving (scanning) direction of the nozzle unit 100 is defined as the X direction (first direction), the direction parallel to the placement surface 161 of the stage 16 and perpendicular to the X direction is defined as the Y direction (second direction), and the direction intersecting the placement surface 161 of the stage 16 (perpendicularly in Embodiment 1) is defined as the Z direction (third direction).

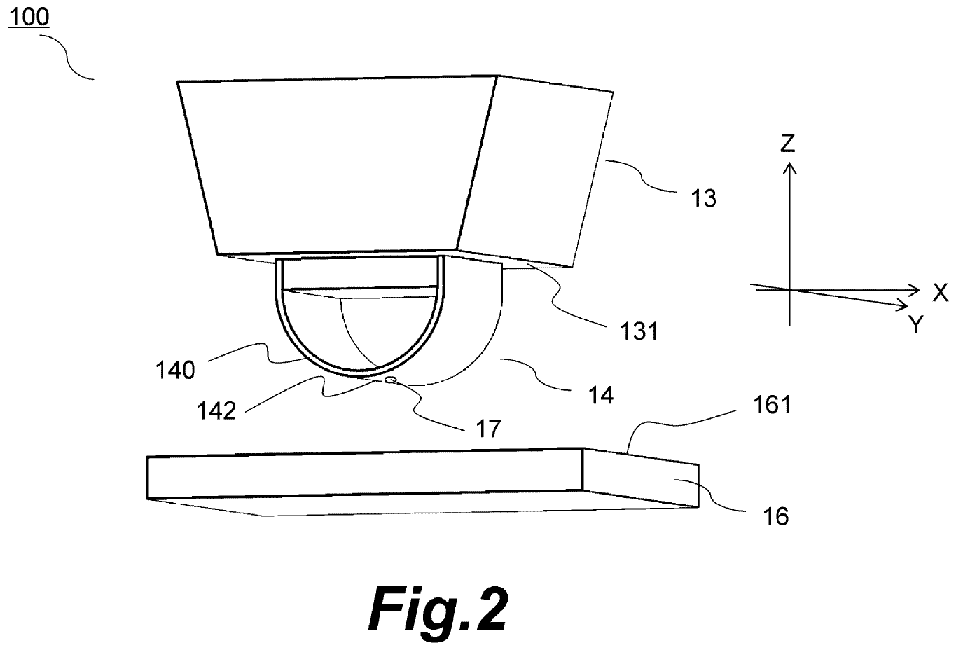

FIG. 2 is a perspective view illustrating the nozzle unit 100. The guide part 13 includes the diaphragm member 14, which is provided with an aperture 17 that lets at least part of the light beam 11 pass through, at an end portion 131 facing the placement surface 161 in the Z direction. The diaphragm member 14 has an arcuate shape convex toward the placement surface 161 in a cross section perpendicular to the Y direction when no external forces are applied, and is elastically deformable in the Z direction. The diaphragm member 14 includes an elastic part 140 at an end portion facing the stage 16 in the Z direction. When processing the workpiece 15, the diaphragm member 14 is pressed against the workpiece 15 placed on the stage 16 in the Z direction, to cause the elastic part 140 to elastically deform in the Z direction. The nozzle unit 100 is moved relative to the workpiece 15 while pressing the workpiece 15 with the elastic force of the elastically deformed diaphragm member 14. In Embodiment 1, the diaphragm member 14 is made by deforming a sheet-like material into an arch so that it protrudes toward the placement surface 161 of the stage 16 (negative direction on the Z axis). The inside of the arch is hollow. The aperture 17 is provided at the top (distal end) 142 of the diaphragm member 14 facing the stage 16.

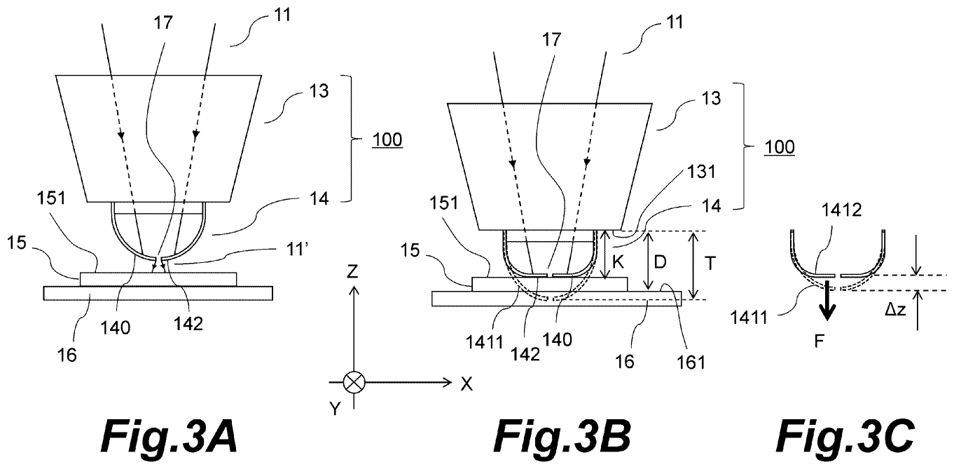

FIG. 3A to FIG. 3C are cross-sectional views of a section perpendicular to the Y direction, illustrating how the nozzle unit 100 undergoes deformation. FIG. 3A shows a cross section of the light beam 11, nozzle unit 100, and workpiece 15. As mentioned above, the light beam 11 passes through the guide part 13. Alight beam 11′ that is at least part of the light beam 11 and has passed through the aperture 17 of the diaphragm member 14 reaches the workpiece 15. FIG. 3A shows a state when there is a gap between the aperture 17 of the diaphragm member 14 and the workpiece 15. In this state, when the aperture 17 of the diaphragm member 14 is small, the light beam 11′ is dispersed by increased diffraction and reaches the workpiece 15. In the state shown in FIG. 3A, there is a gap between the distal end 142 of the diaphragm member 14 in the Z direction and the target surface 151 of the workpiece 15 when no external forces are acting on the elastic part 140 of the diaphragm member 14 (when the elastic part 140 is not elastically deformed).

In Embodiment 1, the nozzle unit 100 is pressed against the workpiece 15, or the workpiece 15 is pressed against the nozzle unit 100, so that the elastic part 140 of the diaphragm member 14 is deformed as shown in FIG. 3B. The length of the diaphragm member 14 in the Z direction (distance from the end portion 131 of the guide part 13 to the distal end 142 of the diaphragm member 14) when no external forces are acting on the elastic part 140 of the diaphragm member 14 (as depicted with broken lines in FIG. 3B) is defined as T here. The distance in the Z direction between the end portion 131 of the guide part 13 and the placement surface 161 of the stage 16 is defined as D. The distance in the Z direction between the end portion 131 of the guide part 13 and the target surface 151 of the workpiece 15 is defined as K. In Embodiment 1, the nozzle unit 100 scans the workpiece at a position where T>D, or T>K. The nozzle unit 100 being thus positioned during the scanning causes the elastic part 140 of the diaphragm member 14 to be pressed in by the workpiece 15 in the Z direction and elastically deformed as depicted with solid lines in FIG. 3B during the scanning process. The elastic force generated by the elastic deformation acts on the workpiece 15 as a pressing force.

As a result, the elastic part 140 of the diaphragm member 14 in the elastically deformed shape 1412 constantly exerts a pressing force F (elastic force) that acts to return to the original shape 1411 on the workpiece 15, as shown in FIG. 3C. This pressing force F is determined by the deformation (amount of deformation) Δz of the elastic part 140 in the Z direction. This way, the aperture 17 and the workpiece 15 can be maintained in the condition without any gap therebetween, so that the light beam 11′ can reach the workpiece 15 before it is dispersed. Namely, the diameter of the aperture 17 can be made smaller than the focal spot size of the light beam 11 to increase the processing resolution. The nozzle unit 100 pressing the workpiece 15 while scanning it ensures that there will be no gap between the diaphragm member 14 and the workpiece 15, thereby preventing dispersion of the light beam 11 caused by diffraction. Thus, micro-patterns can be created on the workpiece 15. While the nozzle unit 100 is moved (scanned) relative to the stationary (fixed) workpiece 15 to form patterns in the example shown here, the workpiece 15 may be moved instead relative to a fixed nozzle unit 100.

Any distortion in the Z direction of the workpiece 15 will cause the distance in the Z direction between the diaphragm member 14 and the workpiece 15 to change when the nozzle unit 100 passes the distortion. A distortion convex in the Z direction will reduce the distance between the diaphragm member 14 and the workpiece 15. The elastic part 140 of the diaphragm member 14 will deform in the Z direction further from the shape 1412 before passing the distortion, exerting a larger pressing force on the workpiece 15. On the other hand, a distortion concave in the Z direction will increase the distance between the diaphragm member 14 and the workpiece 15. The elastic part 140 of the diaphragm member 14 will return to a shape close to the original shape 1411, exerting a smaller pressing force on the workpiece 15. The degree of elastic deformation that elastic part 140 of the diaphragm member 14 undergoes changes in this way in accordance with the distortion in the workpiece 15. The variable pressing force acting on the workpiece 15 allows the diaphragm member 14 to follow the distortion in the workpiece 15 more reliably.

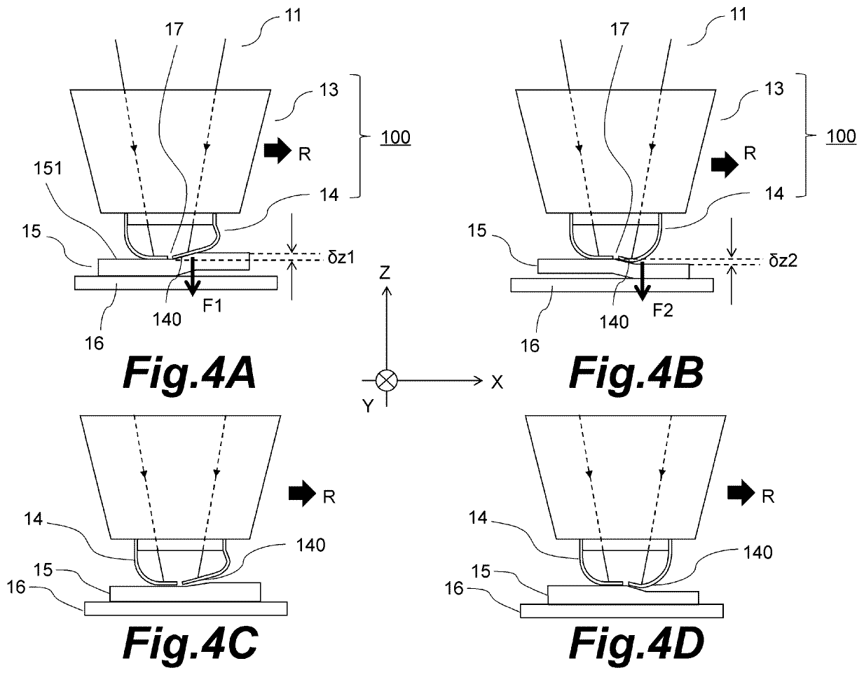

FIG. 4A to FIG. 4D illustrate how the diaphragm member 14 follows distortions in the workpiece 15. The black arrow R in the drawings indicates the moving (scanning) direction of the nozzle unit 100. Distortions in the workpiece 15 include a local displacement from a reference position caused by a warp or deformation even though the thickness is uniform as shown in FIG. 4A and FIG. 4B, and a local displacement from the reference position due to uneven thickness as shown in FIG. 4C and FIG. 4D. As shown in FIG. 4A to FIG. 4D, the diaphragm member 14 of Embodiment 1 is able to follow any type of distortion. FIG. 4A and FIG. 4C show how the diaphragm member 14 undergoes deformation when the workpiece 15 is distorted toward the nozzle unit 100 (convex in the Z direction). In contrast, FIG. 4B and FIG. 4D show how the diaphragm member 14 undergoes deformation when the workpiece 15 is distorted away from the nozzle unit 100 (concave in the Z direction).

When there is a distortion that causes the target surface 151 to come closer to the nozzle unit 100 by δz1 as shown in FIG. 4A relative to a reference position of the target surface 151 of the workpiece 15 where the deformation of the elastic part 140 of the diaphragm member 14 is Δz, the pressing force F1 is determined in accordance with Δz+δz1. When there is a distortion that causes the target surface 151 to move away from the nozzle unit 100 by δz2 as shown in FIG. 4B relative to a reference position of the target surface 151 of the workpiece 15 where the deformation of the elastic part 140 of the diaphragm member 14 is Δz, the pressing force F2 is determined in accordance with Δz−δz2. The pressing force F1 is larger than F, and F2 is F1>F>F2. As can be seen from FIG. 4A to FIG. 4D, even if there is a distortion in the workpiece 15 in the moving direction R of the nozzle unit 100, the diaphragm member 14 deforms and follows the distortion, so that the intensity of the light beam 11′ irradiating the workpiece 15 maintains constant regardless of the distortion in the workpiece 15. This enables uniform microprocessing. Since the diaphragm member 14 is able to follow distortions in the workpiece 15 by deforming flexibly, the diaphragm member 14 can stay in stable contact with the workpiece 15 even when the processing (scanning) speed is raised.

### Embodiment 2

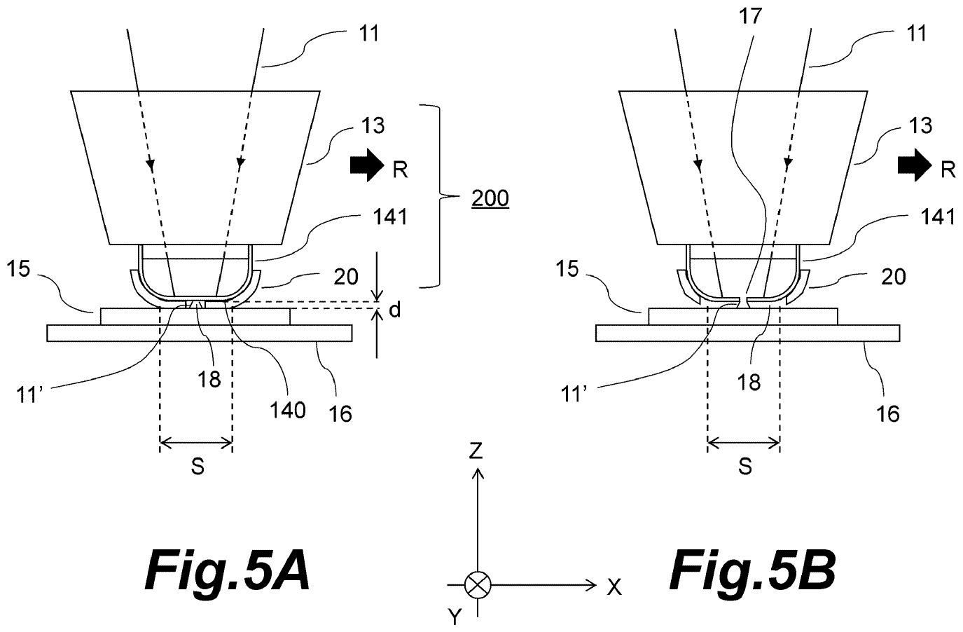

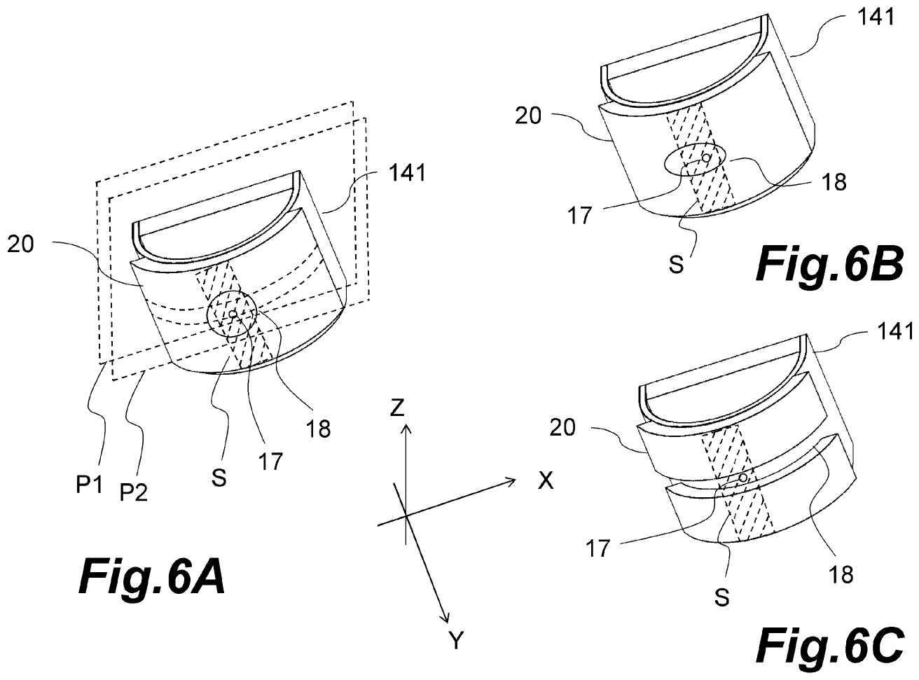

FIG. 5A and FIG. 5B are cross-sectional views of a section perpendicular to the Y direction of a nozzle unit 200 in Embodiment 2 of the present disclosure. FIG. 6A to FIG. 6C are perspective views illustrating a diaphragm member 141 in Embodiment 2. FIG. 5A is a cross-sectional view of section P1 depicted with broken lines in FIG. 6A. FIG. 5B is a cross-sectional view of section P2 depicted with broken lines in FIG. 6A. Section P1 is a section that passes an opening 18 in a first resin layer 20 to be described later and does not pass the aperture 17 in the diaphragm member 141. Section P2 is a section that passes both the opening 18 in the first resin layer 20 and the aperture 17 in the diaphragm member 141.

While Embodiment 2 differs from Embodiment 1 in that the diaphragm member 141 has the first resin layer 20 on the surface in a portion facing the placement surface 161 of the stage 16, the elastic part 140 of the diaphragm member 141 is deformed as it is pressed by the workpiece 15 similarly to Embodiment 1. When the diaphragm member 141 is pressed by the workpiece 15 during microprocessing, the first resin layer 20 deforms with the diaphragm member 141, as shown in FIG. 5A. The first resin layer 20 creates a gap d by its thickness between the aperture 17 of the diaphragm member 141 and the workpiece 15. This configuration can constantly maintain the same gap d between the workpiece 15 and the aperture 17 of the diaphragm member 141 during microprocessing even when there is a distortion in the workpiece 15. This maintains the intensity of the light beam 11′ irradiating the workpiece 15 constant regardless of distortions in the workpiece 15, and allows uniform processing.

The material for the first resin layer 20 may be selected from, but not limited to, heat resistant materials or low friction materials, depending on the environment during the processing. The first resin layer 20 includes an opening 18 for the light beam 11′ that has passed through the aperture 17 to pass through, at the position matching that of the aperture 17 of the diaphragm member 141. The opening 18 is larger than the aperture 17. The workpiece 15 may sometimes produce a mist of volatile components or the like during the processing. If the opening 18 in the first resin layer 20 is small, the aperture 17 of the diaphragm member 141 may be clogged due to the mist adhering and accumulating in the opening 18 in the first resin layer. To prevent this, the opening 18 of the first resin layer 20 should be sufficiently large relative to the aperture 17 of the diaphragm member 141.

As the diaphragm member 141 and first resin layer 20 elastically deform, the first resin layer 20 and the workpiece 15 make contact with each other in a contact portion S that has a certain width in the X direction, as shown in FIG. 5A. FIG. 6A indicates the contact portion S with hatching. As shown in FIG. 6A, the opening 18 has a shape and size that extend beyond the contact portion S in the X direction, so that the opening 18 is not a closed space, as shown in FIG. 5B. Therefore, the mist can easily escape to the outside, and hardly accumulates in the aperture 17.

FIG. 6B and FIG. 6C are diagrams illustrating other examples of the opening 18. The opening 18 in the first resin layer 20, when viewed in the Z direction, may be circular, with a larger diameter than that of the aperture 17 of the diaphragm member 141 as shown in FIG. 6A, or oval or elliptic as shown in FIG. 6B, or a slit-like opening extending in the X direction as shown in FIG. 6C. In the case with an oval or elliptic shape, the opening should preferably be long along the scanning direction (X direction) as shown in FIG. 6B. Offsetting the center of the opening 18 relative to the center of the aperture 17 as shown in FIG. 6B, taking into account the flow direction of mist affected by air currents, can help more reliably secure a mist escape path.

The opening 18 extending beyond the contact portion S in the scanning direction (X direction) allows the mist to readily escape to the outside of the diaphragm member 141, preventing the mist from accumulating. Extending the opening 18 largely in the scanning direction (X direction) as shown in FIG. 6C can widen the opening 18 largely beyond the contact portion S, and can prevent mist accumulation more reliably. Such a configuration can therefore ensure uniform processing over a long period of time.

The first resin layer 20, if too thin, may allow the mist to adhere to the aperture 17 before escaping, and if too thick, may cause dispersion of the light beam 11′ and make the processing difficult. Intensive research conducted by the present inventors led to the finding that the preferable range of thickness of the first resin layer 20 is 50 to 100 μm when the diameter of the aperture 17 in the diaphragm member 141 is φ50 μm.

In both embodiments described above, the diaphragm member 14 should preferably be made of a material having a low absorption rate of the light beam 11 to suppress heat generation. Alternatively, the surface of the diaphragm member 14 may be coated with a material having a low absorption rate of the light beam 11. In this case, materials that do not have a low absorption rate of the light beam 11 can also be used for the diaphragm member 14. A portion of the diaphragm member 14 irradiated with the light beam 11 may be made of, or coated with, a material having a low absorption rate.

Increasing the thickness of the elastic part 140 of the diaphragm member 14 increases the pressing force applied to the workpiece 15. Therefore, the thickness of the elastic part 140 of the diaphragm member 14 may be determined in accordance with a pressing force required for the workpiece 15.

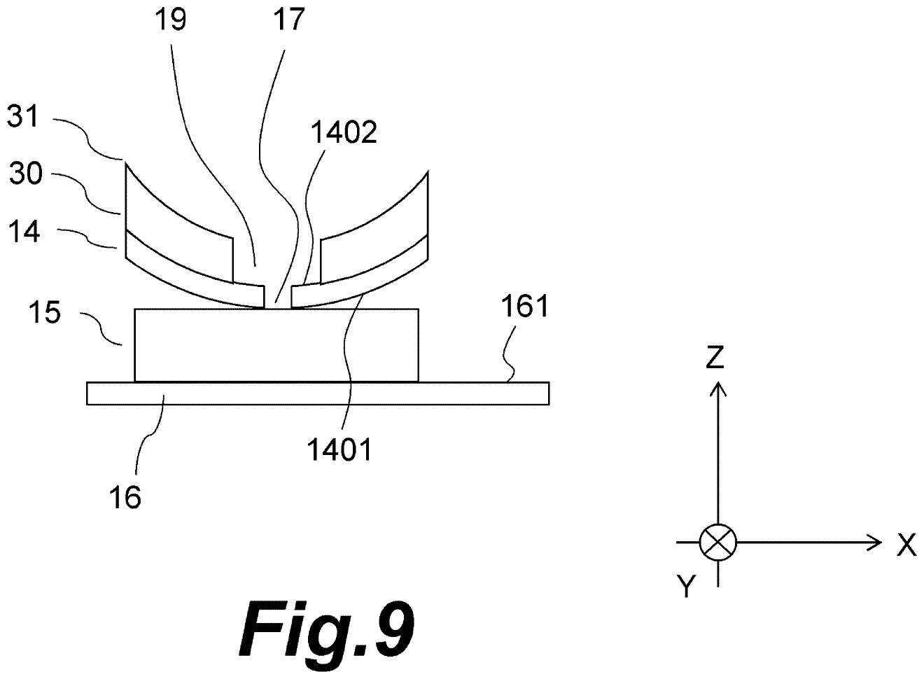

Providing a second resin layer 30 on a surface 1402 inside of the diaphragm member 14 (on a surface on an opposite side of a side on which the surface 1401 facing the placement surface 161 is located) as shown in FIG. 9 can increase the pressing force. The second resin layer 30 should preferably be made of a flexible material. Moreover, a reflection layer 31 that reflects the light beam 11 may be provided on an inner surface of the second resin layer 30 (on a surface on an opposite side of a side on which the diaphragm member 14 is located). This can minimize absorption of the light beam 11 by the second resin layer 30. An opening 19 in the second resin layer 30 and the reflection layer 31 should preferably be larger than the aperture 17 in the diaphragm member 14. This can reduce adverse effects of the light beam 11 on the second resin layer 30. Although not shown in FIG. 9, the diaphragm member 14 may be configured to include both the first resin layer 20 and the second resin layer 30.

Comparative embodiments are described below for comparison with the above embodiments.

### Comparative Embodiment 1

Comparative Embodiment 1 differs from Embodiment 1 in that the diaphragm member 14 of the nozzle unit is not pressed by the workpiece 15. Namely, in the Comparative Example 1, the processing operation is performed in the condition shown in FIG. 3A.

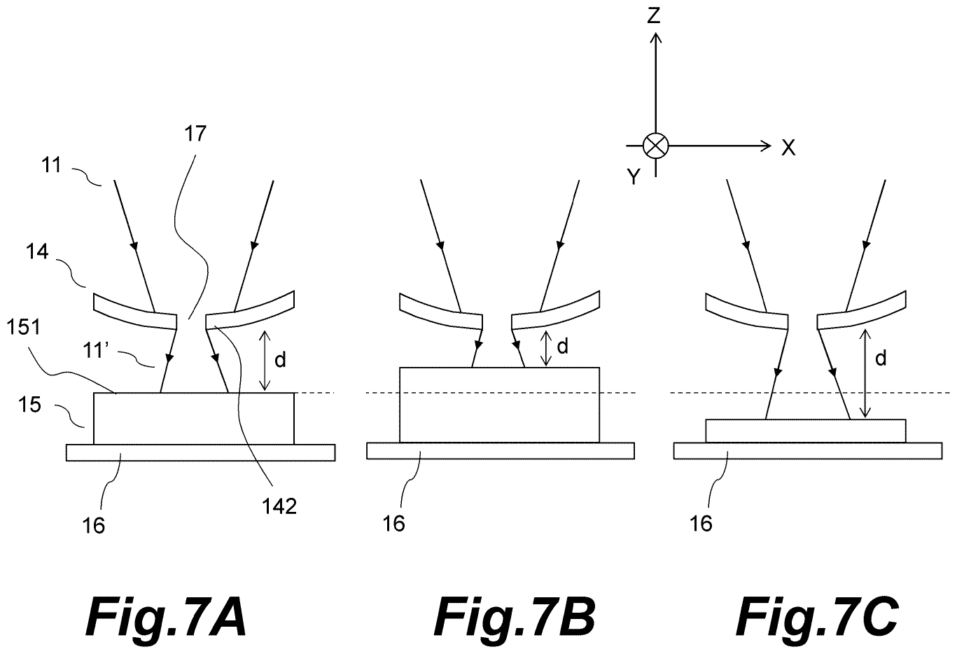

FIG. 7A to FIG. 7C are schematic diagrams showing the positional relationship between the workpiece 15 and the diaphragm member 14 near the aperture 17 in the diaphragm member 14.

FIG. 7A shows reference positions of the diaphragm member 14 and the workpiece 15 relative to each other. Light beam 11′ alone, which is part of the light beam 11, passes through the aperture 17 in the diaphragm member 14, and reaches the workpiece 15. When the aperture 17 has a diameter that is sufficiently small, the light beam 11′ diffracts at the exit of the aperture 17, and proceeds in the gap d between the aperture 17 and the workpiece 15 as it disperses. In Comparative Embodiment 1, the nozzle unit is located at a position where the distance in the Z direction between the distal end 142 of the diaphragm member 14 and the target surface 151 of the workpiece 15 is a positive value when no external forces are acting on the diaphragm member 14, as has been described with reference to FIG. 3A. Therefore, the diaphragm member 14 is not elastically deformed, and does not apply a pressing force on the workpiece 15.

When there is a distortion in the workpiece 15, the nozzle unit cannot follow the distortion in the workpiece 15 in Comparative Embodiment 1, since the nozzle unit is not pressed against the workpiece 15. Namely, the gap d between the aperture 17 of the diaphragm member 14 and the workpiece 15 varies in accordance with the distortion in the workpiece 15.

FIG. 7B illustrates a state where the gap d has become smaller than the reference gap shown in FIG. 7A due to a distortion in the workpiece 15. In this case, the light beam 11′ reaches the workpiece 15 with less diffraction than the case shown in FIG. 7A. Namely, the energy density of the light beam 11′ reaching the workpiece 15 increases as compared to the condition shown in FIG. 7A.

On the other hand, FIG. 7C illustrates a state where the gap d has become larger than the reference gap shown in FIG. 7A due to a distortion in the workpiece 15. In this case, the light beam 11′ reaches the workpiece 15 with more diffraction than the case shown in FIG. 7A. Namely, the energy density of the light beam 11′ reaching the workpiece 15 decreases as compared to the condition shown in FIG. 7A.

Distortions in the workpiece 15 thus reduce the processing uniformity due to the varying gap d in the configuration of Comparative Embodiment 1.

### Comparative Embodiment 2

The optical processing apparatus in Comparative Embodiment 2 differs from that of Embodiment 1 in that no diaphragm member is attached to the nozzle unit. Namely, the light beam 11 entirely reaches the workpiece 15.

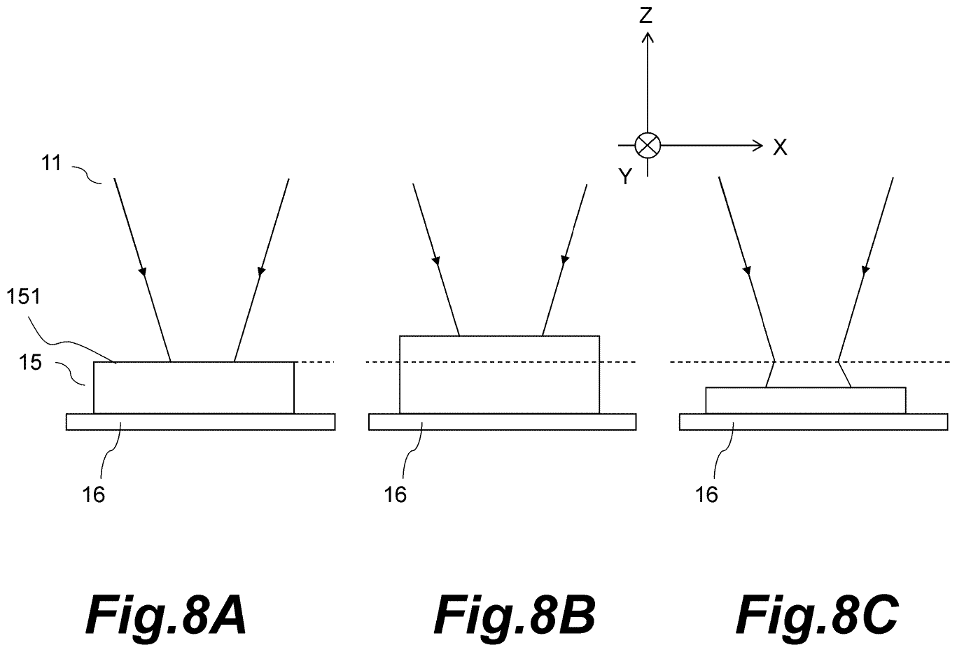

FIG. 8A to FIG. 8C are diagrams illustrating the workpiece 15 near a portion irradiated with the light beam 11.

FIG. 8A illustrates a state where the workpiece 15 is positioned at the focal spot of the light beam 11. Namely, the position in the Z direction of the target surface 151 of the workpiece 15 coincides with the focal point of the light beam 11. The optical processing apparatus in Comparative Embodiment 2 does not include the diaphragm member, and therefore it is difficult to process a pattern finer than the focal spot diameter of the light beam 11 (the spot diameter at the focal point of the light beam 11). Similarly to Comparative Embodiment 1, a displacement in the position of the target surface 151 of the workpiece 15 in the Z direction as shown in FIG. 8B or FIG. 8C due to a distortion in the workpiece 15 causes a change in the energy density of the light beam 11 reaching the workpiece 15. Namely, the processing uniformity is reduced.

### Evaluation

Using the configurations of the embodiments and comparative embodiments described above, the resolution of processed features, processing uniformity, and the durability of the nozzle unit were evaluated. VLS 2.30 from Universal Laser Systems Inc. was used as the optical processing apparatus. The light source 10 is a CO₂ laser oscillator with a wavelength of 10.6 μm and an output power of 10 W. The optical element is a 2.0 lens from Universal Laser System Inc. with 130 μm focal spot diameter. A 20 μm thick copper foil with an aperture 17 was used as the diaphragm member 14. To suppress heat generation, it is preferable to select a metal with a low absorption rate of the CO₂ laser for the diaphragm member 14, such as, for example, gold, silver, copper, aluminum, nickel, iron, molybdenum, and so on. In the case where a material having a high absorption rate of the CO₂ laser is used for the diaphragm member 14, a surface of the diaphragm member 14 may preferably be coated with a material with a low absorption rate. A preferable surface coat is deposited gold or silver, for example. For the second resin layer 30, if it is provided, PET or polyimide may be selected, for example, but the material is not limited to these. Preferable materials for the reflection layer 31, if it is provided, include a metal foil or a deposited film containing one of gold, silver, copper, aluminum, and molybdenum.

The first resin layer 20 in Embodiment 2 should preferably be made of a material that can withstand the heat from the workpiece 15, such as, for example, silicone resin, fluoropolymer, and polyimide resin.

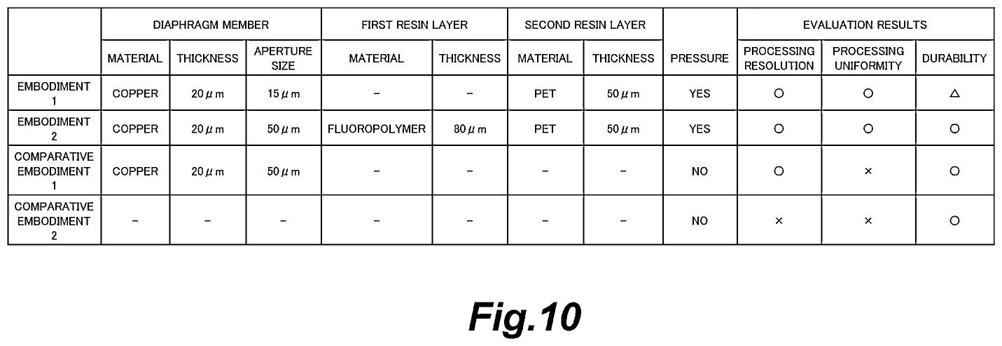

The results of processing workpieces 15 using the above configurations are shown below and in FIG. 10. Polyacetal resin was used as the workpiece 15.

In the evaluation results shown in FIG. 10, the criteria are given as follows.

### Processing Resolution

∘: Enable to process less than the laser spot size
x: Not enable to process less than the laser spot size

### Processing Uniformity

∘: Uniform processed line width
x: Non-uniform processed line width

### Durability

∘: Scanning distance of 400 m or more
Δ: Scanning distance of 20 to 400 m
x: Scanning distance of less than 20 m

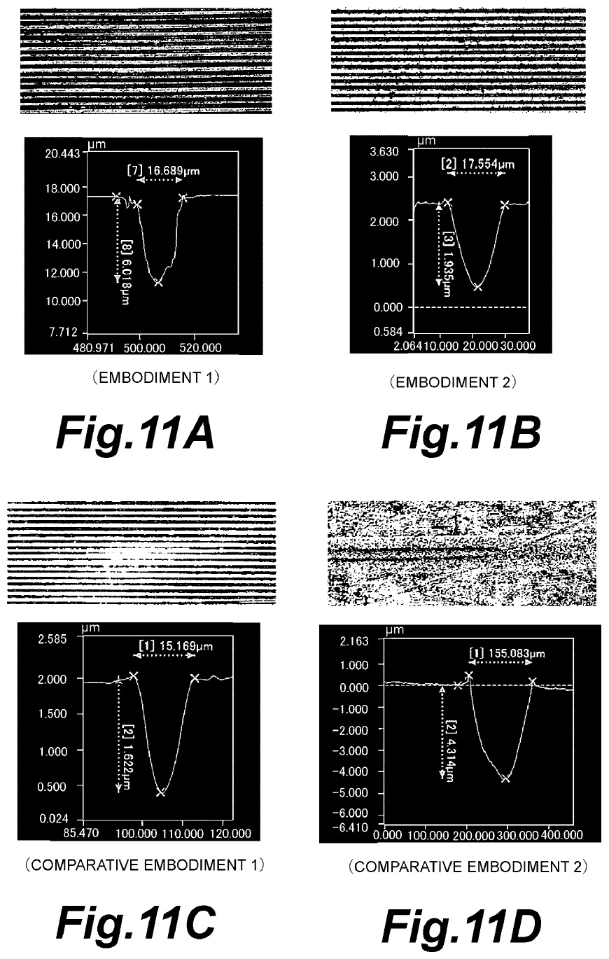

FIG. 11A to FIG. 11D show the processing results. FIG. 11A to FIG. 11D show microscopic images on the upper side, and profile measurement results on the lower side. FIG. 11A, FIG. 11B, FIG. 11C, and FIG. 11D respectively show the results of Embodiment 1, Embodiment 2, Comparative Embodiment 1, and Comparative Embodiment 2. The profile measurement was performed using a laser microscope VK-X1050 manufactured by Keyence Corporation. The processing result was uniform in Embodiment 1, i.e., one example of the processed shape had a line width of 16.7 μm and a depth of 6.0 μm. The processing result was uniform in Embodiment 2, and the processed shape had a line width of 17.6 μm and a depth of 1.9 μm. On the other hand, the processing result was not uniform in Comparative Embodiment 1, even though the processed shape had a line width of 15.2 μm and the depth of 1.6 μm. The processing result in Comparative Embodiment 2 was even less uniform, with a line width of 155.0 μm and a depth of 4.3 μm, even though the output was reduced to minimize the line width as much as possible.

As described above, the configuration according to the present disclosure allows following of large distortions in workpieces even at high scanning speeds. An optical processing apparatus and an optical processing method that enable highly accurate and efficient processing of micro-patterns can thus be provided.

According to the present disclosure, an optical processing apparatus and an optical processing method that allow following of distortions in workpieces regardless of the scanning speed to enable highly accurate and efficient processing of micro-patterns can be provided.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-014043, which was filed on Feb. 1, 2024 and which is hereby incorporated by reference herein in its entirety.

What is claimed is:

1. An optical processing apparatus comprising:
a light source;
an optical element configured to focus light emitted from the light source toward a workpiece;
a nozzle configured to let a light beam focused by the optical element pass through; and
a placement part having a placement surface for placing the workpiece,
the optical processing apparatus being configured to perform a processing operation on a target surface of the workpiece by irradiating the workpiece with the light beam from the nozzle while moving the nozzle and the workpiece relative to each other in a first direction parallel to the placement surface,
wherein the nozzle includes a diaphragm member provided with an aperture in an end portion facing the placement surface, the aperture being configured to let at least part of the light beam pass through, and
wherein the diaphragm member has an arcuate shape convex toward the placement surface in a cross section perpendicular to a second direction when no external forces are applied, and includes an elastic part elastically deformable in a third direction, where the second direction is a direction perpendicular to the first direction and parallel to the placement surface and the third direction is a direction intersecting the placement surface.

2. The optical processing apparatus according to claim 1, wherein, during a processing operation on the workpiece, the nozzle is at a position where a distance in the third direction between the end portion of the nozzle and the placement surface is shorter than a length of the diaphragm member in the third direction in a condition where the elastic part is not elastically deformed, so that the nozzle is moved relative to the workpiece while pressing the workpiece with the elastic force of the elastically deformed elastic part.

3. The optical processing apparatus according to claim 1, wherein the elastic part of the diaphragm member is a metal foil containing any one of gold, silver, copper, aluminum, nickel, iron, and molybdenum.

4. The optical processing apparatus according to claim 1, wherein the elastic part of the diaphragm member has a surface on which gold or silver is deposited.

5. The optical processing apparatus according to claim 1, wherein the elastic part of the diaphragm member includes a first resin layer on a surface facing the placement surface of the placement part.

6. The optical processing apparatus according to claim 5, wherein the first resin layer is made of one of silicone resin, fluoropolymer, and polyimide resin.

7. The optical processing apparatus according to claim 5, wherein the first resin layer includes an opening larger than the aperture of the diaphragm member at a position coinciding with the aperture of the diaphragm member, the opening being configured to let the light beam that has passed through the aperture of the diaphragm member pass through.

8. The optical processing apparatus according to claim 1, wherein the diaphragm member includes a second resin layer on a surface on an opposite side of a side on which a surface facing the placement surface is located.

9. The optical processing apparatus according to claim 8, wherein the second resin layer is made of PET or polyimide.

10. The optical processing apparatus according to claim 8, wherein the second resin layer includes a reflection layer that reflects the light beam on a surface on an opposite side of a side on which the diaphragm member is located.

11. The optical processing apparatus according to claim 10, wherein the reflection layer is a metal foil or a deposited film containing any one of gold, silver, copper, aluminum, and molybdenum.

12. An optical processing method for performing a processing operation on a target surface of a workpiece by an optical processing apparatus,
the optical processing apparatus including:
a light source;
an optical element configured to focus light emitted from the light source toward the workpiece;
a nozzle configured to let a light beam focused by the optical element pass through; and
a placement part having a placement surface for placing the workpiece,
wherein the nozzle includes a diaphragm member provided with an aperture in an end portion facing the placement surface, the aperture being configured to let at least part of the light beam pass through, and
wherein the diaphragm member has an arcuate shape convex toward the placement surface in a cross section perpendicular to a second direction when no external forces are applied, and includes an elastic part elastically deformable in a third direction, where the second direction is a direction perpendicular to a first direction parallel to the placement surface and parallel to the placement surface, and the third direction is a direction intersecting the placement surface,
the optical processing method comprising:
pressing the diaphragm member against the workpiece to elastically deform the elastic part;
moving the nozzle in the first direction relative to the workpiece while pressing the workpiece with an elastic force of the elastically deformed elastic part; and
irradiating the workpiece with the light beam from the nozzle while moving the nozzle and the workpiece relative to each other in the first direction to perform a processing operation on the target surface of the workpiece.
